(19) United States
(12) Patent Application Publication
(10) Pub. No.: US 2007/0136106 A1
(43) Pub. Date: Jun. 14, 2007

(54) Method and system of managing and administering automotive glass repairs and replacements

(76) Inventors: Gary Hart, Scottsdale, AZ (US); Maria Iorio, Glendale, AZ (US); David Malone, Carefree, AZ (US); John S. Witt, Scottsdale, AZ (US); Antonio Morales, Scottsdale, AZ (US); Lisa Johnston, Phoenix, AZ (US); Barry Weeg, Phoenix, AZ (US)

Correspondence Address: HAHN LOESER & PARKS, LLP, One GOJO Plaza, Suite 300, AKRON, OH, 44311-1076, US

(21) Appl. No.: 11/298,214

(22) Filed: Dec. 9, 2005

(51) Int. Cl. G06Q 40/00; A01K 5/02

(52) U.S. Cl. 705/4; 705/29

(57) ABSTRACT

A processing system includes one or more computers having a plurality of software modules that are connected to the Internet for remote access by an insurance companies and glass repair shops alike. The processing system manages the storage and retrieval of insurance claim information for the repair of automotive glass. Claim information is entered into the processing system whereby insurance claims are automatically processed for approval or disapproval of the repair based upon the information stored in the processing system. The processing system analyzes claim data against policy information and the current NAGS pricing specification. Work orders are automatically dispatched to the glass repair shop.

### FIELD OF THE INVENTION

This invention relates to automotive glass claims processing systems, and more particularly to managing and administering claims for insurance companies, insurance agents, automotive repair and replacement companies vehicle owners, as well as third party administrators and the automotive glass supply chain.

### BACKGROUND

Typically, facilitating automotive glass claims made upon insurance policies, the self-insured or other similar mechanisms have been resource and time intensive processes, especially when it comes to the reporting, processing and releasing of funds. Traditionally, the steps involved in the process of facilitating these types of AGR (Automotive Glass Repair) claims have been: first notice of loss, loss classification, repair or replacement, pricing negotiation, repair or replacement facilitation, supply chain management and parts procurement, settlement and distribution of payment, process management and analysis.

To start an AGR claim, the initial step is first notice of loss or FNOL. As depicted in FIG. 1, an insured entity 13 or individual makes contact with either their insurance company 21 or directly with an AGR shop 23. In either case, the process is usually reported by telephone to the insurer or its authorized agent, in the case of a repair or replacement claim against an insurance policy. In the case of the AGR industry, most claims are subsequently reported to a third party administrator called a network.

The network determines the extent of the loss by evaluating the type of damage and the location of the damage on the vehicle. If the damage is in the visible area of the drivers view a replacement of the windshield is determined, otherwise repair of the damaged glass is considered.

The network verifies policy coverage and then is required to ask the insured if he or she has a preference for a company to complete the replacement or repair job. In most cases, the insured entity or individual allows the network to schedule and dispatch the claim to an authorized AGR shop of the network's choosing. The dispatch is made usually by telephone and/or facsimile. The authorized AGR shop has an agreement with the network to perform the job for a pre-set discount off of the industry standard pricing. This pricing specification is known as NAGS, which is an acronym for National Auto Glass Specification. NAGS specifies discounts that can apply to any area of the job including glass components, adhesives, parts and labor.

Once the AGR shop has accepted the claim, it is then entered into a production schedule, usually by a manual process. The claim information is entered into a point-of-sale system or POS, which may be a computerized system. The POS system allows the shop to lookup NAGS information, prepare internal work orders and invoice the work. Other POS functions may include accounting, scheduling and limited customer relationship management or CRM. The AGR shop manually orders product through distributor relationships and then performs the repair or replacement work. An AGR shop may utilize a paper or a computerized system to track parts purchased from a variety of suppliers. Suppliers may have eclectic systems for purchasing the necessary parts. At times, ascertaining the availability and/or delivery of the required parts, which may be backordered, can be cumbersome. Once a signed work order is returned to the AGR shop, the job is invoiced and is sent using a method called EDI (Electronic Data Interchange). The EDI transaction travels through the POS vendor's value-added-network (VAN) where it is then transacted to the network. The AGR shop typically pays a per EDI transaction fee. If the AGR shop manually submits the claim to the network by mail or facsimile, it is usually charged a premium for doing so. For all non-insurance claim jobs, the AGR shop simply completes the transaction in the POS system and collects from the vehicle owner.

When the network receives an invoice from the AGR shop, it verifies that the invoice meets the discount pricing agreement. If the invoice is rejected, the shop must correct the error and resubmit the claim or provided a valid exception request. During this process, the AGR shop may be billed a premium for the resubmission of the claim, which may be faxed or sent using EDI. Once the invoice is approved, it is then processed for payment based on the frequency of payment approved by the network. This payment process can occur manually or electronically and takes anywhere from six (6) to eight (8) weeks. Some networks provide limited access to the status of the claim either by telephone or by Internet. The access of this information however is not available though the AGR shop's POS system.

After the invoice approval process, the network bills the insurer a fee that is negotiated from a guaranteed base discount of NAGS. The difference between this discount and the discount the shop must provide is the basis of revenue for the network. A payment is then disbursed to the AGR shop by check or electronic funds transfer once the payment cycle has been reached by the network. The AGR shop must then reconcile the payment in the POS system, a separate accounting system or both.

The network usually provides limited information about the claim to the insurer. A report format similar to a spreadsheet or other data component can be used. The insurer must use this information to perform a series of administrative tasks with regard to the involved policies. In most cases, this process requires excessive manual labor and the re-keying of information in disparate systems.

Management and analysis is complex and difficult due to the lack of common systems and data transactions. Insurer and agents require information to fulfill certain business metrics on the program costs, repair or replacement costs, cycle times, and customer satisfaction just to name a few. The data gathered from the delivery by the network yields only a small portion of this information making analysis inaccurate, and the ongoing analysis conducted is usually then based on aging or outdated information.

The systems used by a network to facilitate the handling of these processes are not configurable and cannot be standardized for commercial use. Moreover, because of the lack of a standardized system, the process itself involves a variety of delays and inefficiencies. The administrative overhead to handle the processes fiscally harm the AGR shop and their suppliers because the POS systems provides little or no integration with the network, other than EDI for invoicing, or direct participation with the insured or its agents.

Each of the current processes presents complexities and difficulties. Current networks and POS vendors each focus on a single or relatively few of these steps involved and usually require the re-collection, re-entry or reformatting of the claims data to, cater to each of the specific needs of the process or one another. The electronic systems used and offered by the networks and POS vendors are each based on proprietary systems, formats and communication systems that require the redundant re-entry of information across the process. Bottlenecks are therefore created because the process becomes people intensive with significant human involvement for phone calls, data collection and entry of the data. Further, these delays present considerable inconvenience to the insurer, their agents and the customer and impact the insurers cost of adjusting the claim harming their loss adjustment expenses.

Accordingly, there is a need for a centralized, automated and standards based systems for reporting, processing and releasing funds for automotive glass claims. The embodiments of the subject invention obviate the aforementioned problems.

### BRIEF SUMMARY

The invention is an industry standards based, centralized and automated system that allows for the reporting, processing and management of AGR claims. More particularly, the system and method processes, allows for the complete integration of the industry from FNOL through payment and management. The invention is composed of sub-systems or modules that can operate in conjunction with one or more sub-systems, whether internal or external, or operate in a standalone fashion. Certain embodiments of the modules may include: the claim management module, the claims manager administrative module, the first notice of loss module, the claims payment module, the claims manager reporting module, the shop management module, the Total Shop Management or TSM Administration module, the quotes & invoicing module, the repair order sub-module, the invoicing sub-module, and the messaging module.

The claim management module and claim management user interface (Claims Manager) allows a user to access, add, edit, and view claim data. Claims Manager is the main module for other components contained in the modules that make up the Claims Manager system.

The Claims Manager Administrative module allows the user to setup and define the use of the Claims Manager system. This module contains company management, user management, agent management, offer and acceptance management and remittance management.

The FNOL module captures the initial loss information and allows the user to enter claim information based on the requirements determined in the company management and offer and acceptance management. Further, the module allows for the locating of AGR shops and the subsequent dispatch to these locations. The module can interact with third-party systems such as policy systems either in real-time or offline.

The claims payment module allows the system to approve or reject invoices, process exception requests and facilitate the payment of approved claims based on company policy. In the case of payment, the module can interact with third-party payment services such as bank or EFT networks or internal accounting systems.

The Claims Manager reporting module allows the user to access, add, edit and view custom reports based on any of the information contained in the subscribers Claims Manager database, in real-time.

The shop management module and shop user interface (Total Shop Management—TSM) allows the user to access, add, edit and view job and claim data. TSM is the main module for the other components contained in the modules that make up the TSM system.

The TSM Administration module allows the user to define the use of their TSM account. This module contains company management, user management, sales tax management, and parts profile management.

The Quotes & Invoicing module allows the user to manage job assignments, query the NAGS database, access-add-edit and manage Quotes, Repair Order and Invoices. The module also contains a Scheduling sub-module that allows the user to access, add, edit and manage technician schedules as it pertains to Repair Orders. In addition, the Scheduling sub-module also allows for the automatic route planning based on the technician's schedule.

The Repair Order sub-module allows the user to connect to external trading partner systems such as distributors to query parts availability and pricing. Further, the connection allows the user to manage their trading partner accounts including payments and ordering.

The Invoicing sub-module allows the user to submit the invoice in any method including by print, electronic facsimile, EDI/XML to networks and directly to an eDirectGlass claims management account.

The Messaging module allows the user to communicate with a Claims Manager account in real-time and on a claim basis.

Yet another aspect of the processing system 1 may include the capability to store, create, retrieve, purchase and manage inventory from the supply chain 52 by various users 5 or subscribers of the processing system 1.

One aspect of the embodiments of the subject invention include a method of processing automotive glass repair claims by providing a processing system having at least a first logic processor and memory storage, the processing system being adapted to manage a plurality of data, the processing system being adapted for selective communication to a remote device, establishing at least a first user account with the processing system for allowing remote communication access to the plurality of data, storing at least a first set of criteria for automatically approving the repair of automotive glass claims, establishing a remote connection to the processing system through the at least a first user account, receiving at least a first claim request for repairing an associated automotive glass article, and, automatically determining an approval response to the at least a first claim based on the at least a first set of criteria.

Another aspect of the embodiments of the subject invention includes providing a processing system having at least a first logic processor and memory storage, the processing system being adapted to manage a plurality of data, the processing system being adapted for selective communication to a remote device, the processing system having one or more modules.

Yet another aspect of the embodiments of the subject invention includes providing a processing system having at least a first logic processor and memory storage, the processing system being adapted to manage a plurality of data, the processing system being adapted for selective communication to a remote device, the processing system having a first software module for receiving claim requests.

Still another aspect of the embodiments of the subject invention includes providing a processing system having at least a first logic processor and memory storage, the processing system being adapted to manage a plurality of data, the processing system being adapted for selective communication to a remote device, wherein the memory storage contains at least a first portion of a database.

Yet another aspect of the embodiments of the subject invention includes storing at least a first set of criteria for automatically approving the repair of automotive glass claims in the at least a first portion of the database.

Even another aspect of the embodiments of the subject invention includes establishing at least a first administrative entity account with the processing system for allowing remote communication access of at least a first administrative entity to the plurality of data.

Another aspect of the embodiments of the subject invention includes establishing at least a first repair entity account with the processing system for allowing remote communication access of at least a first repair entity to the plurality of data.

Yet another aspect.,of the embodiments of the subject invention includes establishing at least a first insuring entity account with the processing system for allowing remote communication access of at least a first insuring entity to the plurality of data.

Still yet another aspect of the embodiments of the subject invention includes establishing a remote connection over a wide area network to the processing system through the at least a first user account.

Even yet another aspect of the embodiments of the subject invention includes establishing a remote connection over the Internet to the processing system through the at least a first user account.

Yet another aspect of the embodiments of the subject invention includes receiving at least a first claim request from an associated repair entity for repairing an associated automotive glass article.

Still another aspect of the embodiments of the subject invention includes receiving at least a first claim request from an associated insured party for repairing an associated automotive glass article, entering claim data into the processing system, and, dispatching a work order to an associated repair entity responsive to receiving the at least a first claim request.

Even another aspect of the embodiments of the subject invention includes dispatching a work order to an associated repair entity responsive to receiving the at least a first claim request and responsive to data accumulated from the associated repair entity.

Still another aspect of the embodiments of the subject invention includes dispatching a work order to an associated repair entity responsive to receiving the at least a first claim request and responsive to historical repair data of the associated repair entity.

Yet another aspect of the embodiments of the subject invention includes updating NAGS pricing specification into the processing system, and, automatically determining an approval response to the at least a first claim based on the at least a first set of criteria and the NAGS pricing specification.

A further aspect of the embodiments of the subject invention include providing a computer processing system having at least a first microprocessor and electronic memory storage, the computer processing system including one or more modules to manage the storage and retrieval of a plurality of associated data stored in a computer processing system database, providing at least a first associated repair entity, providing at least a first associated insurance carrier entity, establishing a user account for the at least a first associated repair entity for authorized access the computer processing system, establishing a user account for the at least a first associated insurance carrier entity for authorized access the computer processing system, entering data for an insurance claim into the computer processing system from a remote location via a wide area network, storing the data for an insurance claim in the database, storing criteria for approving an insurance claim, accessing the criteria for arriving at an approval decision for the insurance claim, automatically analyzing the data for an insurance claim responsive to the criteria for insurance claim approval, and, determining a response to the approval process of the insurance claim.

Yet another aspect of the embodiments of the subject invention includes notifying the at least a first associated repair entity of the response to the approval process using a computer processing system generated response.

Still another aspect of the embodiments of the subject invention includes retrieving criteria for arriving at an approval decision for the insurance claim from the at least a first associated insurance carrier entity.

Still yet another aspect of the embodiments of the subject invention includes storing criteria for arriving at an approval decision for the insurance claim in the electronic memory storage, and, retrieving criteria for arriving at an approval decision for the insurance claim from the electronic memory storage.

Even another aspect of the embodiments of the subject invention includes periodically updating the criteria for arriving at an approval decision for the insurance claim in the electronic memory storage from the at least a first associated insurance carrier entity.

Still another aspect of the embodiments of the subject invention includes providing a processing system having at least a first logic processor and memory storage, the processing system being adapted to manage a plurality of data, the processing system being adapted for selective communication to a remote device, establishing at least a first user account with the processing system for allowing remote communication access to the plurality of data, storing at least a first set of criteria for automatically approving the repair of automotive glass claims, establishing a remote connection to the processing system through the at least a first user account, receiving at least a first claim request for repairing an associated automotive glass article, accessing data for automatically verifying insurance policy coverage, automatically determining an approval response to the at least a first claim based on the at least a first set of criteria, receiving at least a first invoice request for repairing the associated glass article, and, automatically approving the at least a first invoice request based upon the determined approval response.

Even still another aspect of the embodiments of the subject invention includes establishing a first user account with the processing system for allowing an associated repair entity remote communication access to the plurality of data and at least a second user account with the processing system for allowing an associated insurance carrier entity remote communication access to the plurality of data.

Still yet another aspect of the embodiments of the subject invention includes automatically generating a disbursement request for payment of the at least a first invoice, and, sending the disbursement request to the associated insurance carrier entity.

### BRIEF DESCRIPTION OF THE DRAWINGS

FIG. 1 is a schematic representation of the prior art system showing the interaction of the insurance companies, third party administrators, insured entity and automotive glass repair shop.

FIG. 2 is a schematic representation of a centralized processing system having one or more software modules and a database for facilitating the repair of an automotive glass insurance claim.

FIG. 2a is a schematic representation of a centralized processing system having one or more computers networked together and to a wide area or other network in accordance with the embodiments of the subject invention.

FIG. 2b is a schematic representation of an embodiment of the present invention depicting the glass repair claim process utilizing the processing system.

FIG. 3 is a schematic representation of the front windshield of a vehicle having damage to a particular region.

FIG. 3a is a schematic representation of an example damage pattern for a glass panel.

FIG. 3b is a schematic representation of an example damage pattern for a glass panel.

FIG. 3c is a schematic representation of an example damage pattern for a glass panel.

FIG. 3d is a schematic representation of an example damage pattern for a glass panel.

FIG. 4 is a block diagram of submitting a glass repair claim according to the embodiments of the subject invention.

FIG. 5 is a schematic representation of a display module screen according to the embodiments of the subject invention.

FIG. 6 is a schematic representation of a display module screen according to the embodiments of the subject invention.

FIG. 7 is a schematic representation of a display module screen according to the embodiments of the subject invention.

FIG. 8 is a schematic representation of a display module screen according to the embodiments of the subject invention.

FIG. 9 is a schematic representation of a display module screen according to the embodiments of the subject invention.

FIG. 10 is a schematic representation of the process for managing a glass repair claim by a mobile glass repair facility.

FIG. 11 is a schematic representation of a display module screen according to the embodiments of the subject invention depicting the invoicing of glass repair claim.

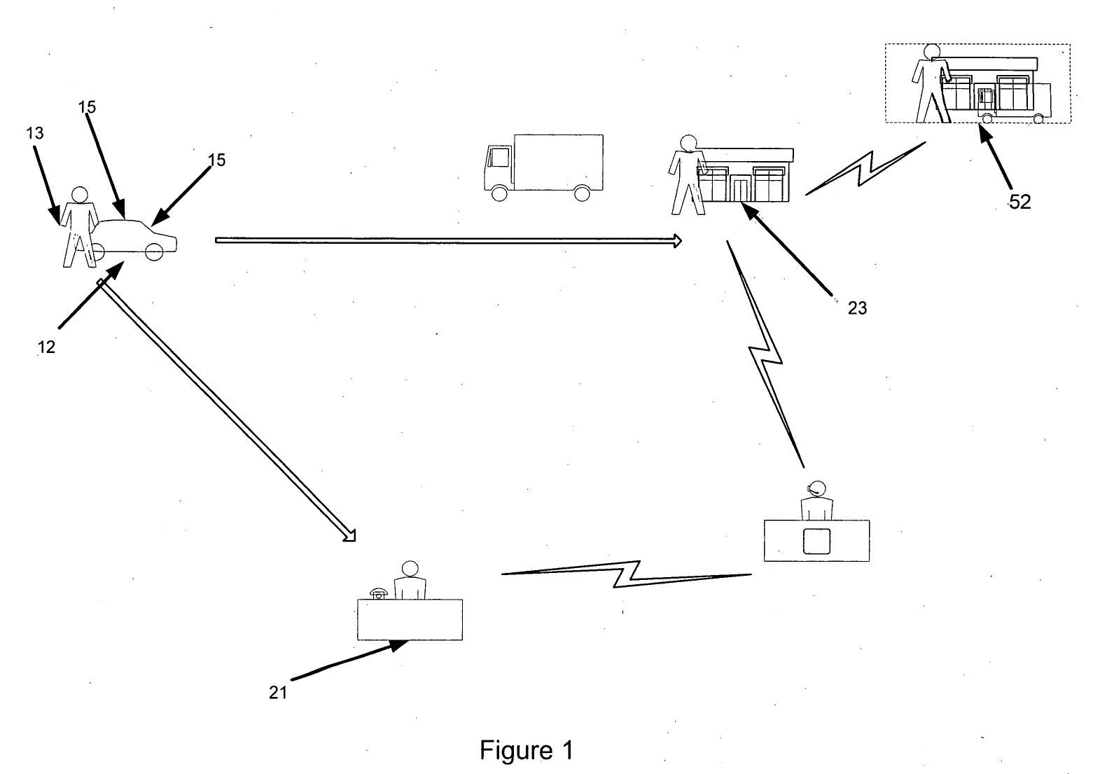

### DETAILED DESCRIPTION

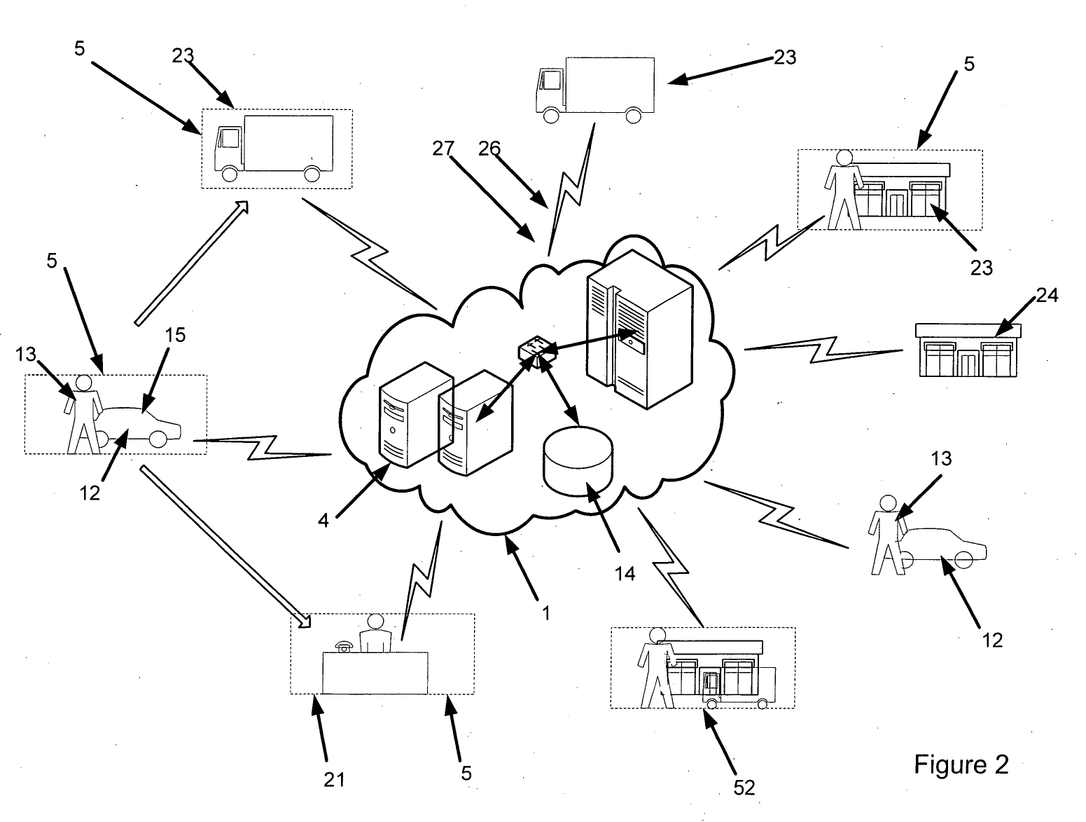

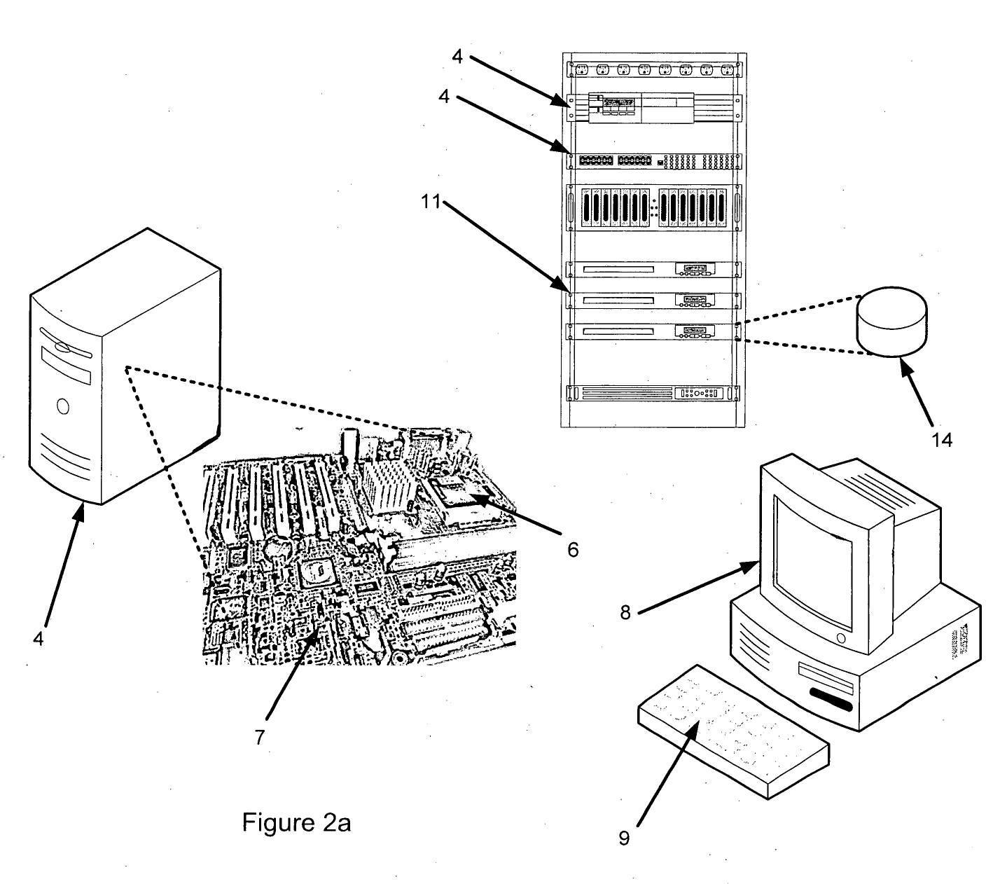

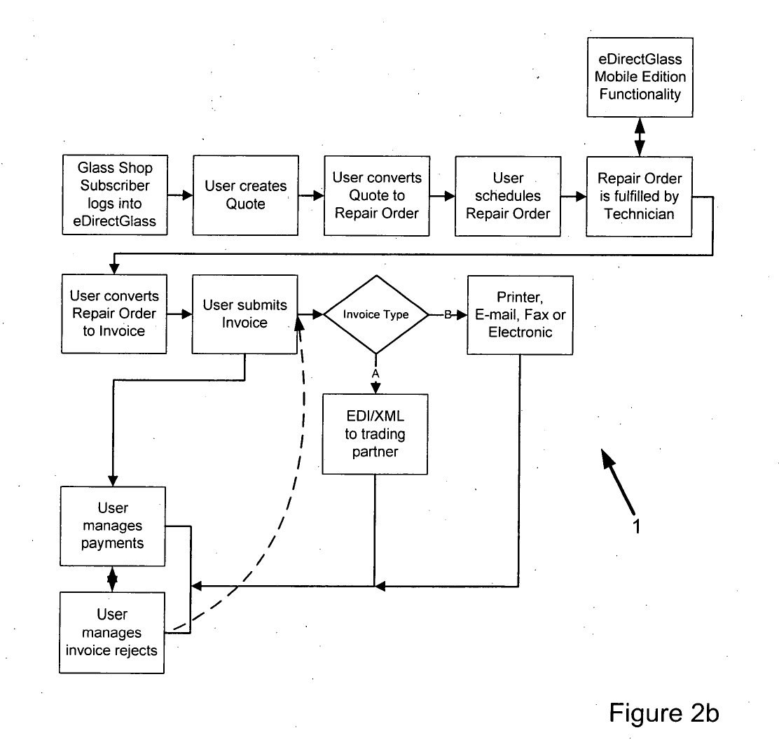

Referring now to the drawings wherein the showings are for purposes of illustrating embodiments of the invention only and not for purposes of limiting the same, FIG. 2 and 2b depicts a repair glass claims processing system shown generally at 1. The processing system 1 may facilitate the processing of an insurance claim for the repair of an automotive glass panel 15, such as a windshield or other glass member in a vehicle 12. The processing system 1 may be connected to a wide area network 26 or the Internet 27 for use in allowing remote communication access to the processing system 1. The processing system 1 may include hardware and/or a plurality of modules, which may be user modules, designed to facilitate interaction and the standardized exchange of information between the various users 5 or subscribers of the processing system 1, as will be discussed further in subsequent paragraphs. The modules may be implemented via one or more software platforms. That is to say that the processing system 1 may be a computer processing system 1 running one or more different software programs over a network. The users 5 or subscribers of the processing system 1 may comprise, but are not limited to: glass repair shop owners or representatives, insurance company agents or representatives, insured users of a vehicle insured by the insurance company, and suppliers of materials. It is noted here that existing third party administrators may also subscribe to the processing system 1 for authorized access. The processing system 1 allows for the storage, management, processing and retrieval of claim related data by allowing the various users of the processing system 1 access to the appropriate data. The users 5 may input claim data into a centralized database, depicted generally at 14, as well as pertinent claim-processing rules. In this manner, the processing system 1 provides a common platform for processing glass repair claims.

With continued reference to FIG. 2 and now also to FIG. 2a, the processing system 1 may include one or more processor-based systems 4 such personal computers, servers, work stations, along with portable processor based devices. In one embodiment, the processing system 1 may comprise a series of processor-based computers 4 networked together to perform the functions of the processing system 1. In an alternate embodiment, a mini-computer 4 or mainframe computer 4 may be used in accordance with the embodiments of the subject invention. The computers 4 may include, as is known in the art, one or more microprocessors 6 having support circuitry depicted generally at 7. The support circuitry 7 may include electronic memory, such as RAM or ROM along with other peripheral support circuitry that facilitate operation of the computers 4. The computers 4 may also include data storage devices such as hard disk drives, optical storage devices, flash memory, and the like for the storage and retrieval of insurance claims data and other information. The computers 4 may further incorporate or be connected to various output devices such as display monitors 8 and printers. It is noted that some of the output devices may reside in a remote location and may not be directly connected to the computers 4 of the processing system 1. The computers 4 may utilize any type of input device for the processing of insurance claim data such as keyboards 9, scanners, and bar code readers. Still, any type of computer related I/O (Input/Output) device that facilitates the processing of information with the computers 4 may be chosen with sound engineering judgment. The processing system 1 may further include network cards and/or transceivers for connecting to a wide area network 26, such as the Internet 27. The connection to the wide area network 26 may be both a direct connection via various hardwire connections or connection through wireless communication networks. It is noted at this point that any communication protocol may be used to transmit information to and/or from the processing system 1. In that the construction of computers and the use of peripheral equipment are well known, no further explanation of the computer configuration will be offered at this time.

With continued reference to FIG. 2a, as previously mentioned the processing system 1 may comprise-multiple computers 4. The computers 4 used in the processing system 1 may include workstation and/or server computers connected together by way of various switches or hubs 11. In one embodiment of the subject invention, the computers 4 may be rack-mounted computers 4 located in a single facility. Alternatively, the computers 4 of the processing system 1 may be located at different facilities, being interconnected via a network, which may be a closed or dedicated network. However, it is noted that any manner of securely setting up communication between the computers 4 of the processing system 1 may be chosen with sound engineering judgment as is appropriate for use with the embodiments of the subject invention.

As mentioned above, various software modules may be installed onto the computers 4 of the processing system 1. The software modules may be programmed in any high or low level programming language as is appropriate for use with the embodiments of the subject invention. The modules may be implemented on one or more computers 4 and communicated together over a wide area network for use by a plurality of subscribers 5 to the system. In one embodiment, the modules may be accessible via the Internet 27 having at least portions of the modules programmed in a mark-up language like HTML or XML. In this manner, the modules may facilitate the interaction of remote subscribers with the processing system 1 over the Internet 27 as will be discussed in detail in the following paragraphs. Accordingly, security hardware and software may be incorporated to authenticate the subscribers 5 of the processing system 1. In that not all of the users require access to the same type data with the processing system 1, security measures may be implemented to limit access of a particular subscriber to only those modules for which the subscriber 5 needs to view and/or enter data. In an exemplary manner, some of the modules may include: the claim management module, the claims manager administrative module, the first notice of loss module, the claims payment module, the claims manager reporting module, the shop management module, the Total Shop Management or TSM Administration module, the quotes & invoicing module, the repair order sub-module, the invoicing sub-module, and the messaging module, as discussed above.

The modules function to provide a user interface between the subscribers 5 of the processing system 1 and the data that is contained therein. As mentioned above, the subscribers 5 to the system may comprise insurance companies 21, glass repair facilities 23, processing system administrators and insured entities 13. A subscriber 5 to the processing system 1 may be set up in the system as a user during the subscription process. A user name and password may be assigned to the subscriber 5, which includes a security profile that provides appropriate access to the various data in the processing system 1. In one embodiment, various users 5 of the processing system 1 may have different levels of security access with the processing system 1 allowing them to access to a particular module. In an alternative embodiment, a user 5 with a particular security profile may have access to a particular module for the purpose of viewing data, but may not have access to edit the data. For example, an insurance company 21 may have authorization to view data related to a specific repair for which the insurance carrier is responsible. However, only the AGR repair shop subscriber may have authorization to edit the data. It is to be construed that any manner of setting up security profiles for allowing access of a subscriber 5 to the processing system 1 may be chosen as is appropriate for use with the embodiments of the subject invention. It is noted that while the processing system 1 may work in conjunction with insuring entities and third party administrators, to be discussed in detail below, the AGR repair shop may independently utilize any aspect of the processing system 1 when facilitating a glass repair. In other words, it may not be required that AGR repair shops interact with an insuring entity or third party administrator. For example, the owner of the vehicle being repaired may pay for a glass repair in cash or via other means. Additionally, a warranty situation may also arise wherein all aspects of the warranty repair may be handled solely by the repair shop. It is to be construed that the processing system 1 may be utilized in any manner and by any entity for affecting the repair of an automotive glass panel.

In one embodiment the processing system 1 may work in conjunction with a plurality of insurance companies 21. As is well known in the art, an insurance company has many insured individuals. Each of the insured individuals may have in turn a specific insurance policy, which defines the extent of coverage that the insurance company is obligated to cover in the event of glass damage. For example, an insurance policy may stipulate a deductible or other predetermined amount that the insured individual is responsible to pay for any submitted claim. Beyond that amount, the insurance company 21 would be responsible for paying the balance. Another factor defined in an insurance policy may include what kind of damaged will be covered under the specific policy or a time period for which the insured is to be covered under the policy. It will be appreciated by those skilled in the art that there are many factors or criteria that may be included in a specific insurance policy. Further examples will not be offered at this point. An insurance company or insuring entity 21 may subscribe to the processing system 1. As mentioned previously, a processing system administrator may assign a user name and password to the insuring entity 21 having certain levels of access to the data in one or more modules. Initially, a representative of the insurance company 21 may logon to the processing system 1 and enter insurance policy information via one or more processing system modules. The insuring entity 21 may enter specific data related to individual insurance policies. Additionally, the insuring entity 21 may also enter information into the processing system regarding the approval of an insurance claim. Certain rules may be entered and stored within the database of the processing system that can be used to automatically to accept or reject a glass repair claim. The approval decision may be based upon the type of damage, where the damage occurred on the vehicle, current payment status of insurance premiums, warranty status, as well as other factors. However, any criteria may be entered into the processing system 1 and used for determining the acceptance or rejection of a glass repair claim. Accordingly, the insuring entity 21 may logon to the processing system 1 and update the data and/or rules contained therein as needed. Entering and/or updating the information into the processing system 1 may be input by manual means. That is to say that an individual may manually logon to the processing system 1 and manually enter data via a keyboard, scanner or other input device. It is contemplated that entering and/or updating insurance policy information and approval criteria may also be input via a computerized batch process. In this way, the subscriber's name and password may be utilized by a computer program to gain access to the processing system 1, after which once the account has been properly established, the outside computer may transfer larger amounts of data to the processing system 1 in a more efficient manner. However, it is noted here that any manner of establishing proper security access to the processing system 1 and transferring or editing information in the processing system 1 may be chosen with sound judgment. Once completed the insuring entity 21 will have vital information stored in the database 14 of the processing system 1 for access by other subscribers 5 as properly authorized by the system.

In a similar manner, a glass repair facility 23 or glass repair entity 23, which may be a repair shop 23, mobile repair shop 23 or other repair center 23 may also subscribe to the processing system 1. The repair entity 23 may be entered into the processing system 1 by the appropriate administrative procedure wherein the repair entity 23 is provided with a user name and password. That is to say that a user account may be established for the repair entity 23. It will be appreciated that any number of repair shops may subscribe to the processing system 1 and be set up with a unique subscriber account. Accordingly, the user name and password will have a security profile linked with the account allowing the user to gain access to the appropriate modules. Initial information about the repair entity 23 may be entered into the processing system 1 including contact information, a list of authorized representatives, repair capabilities, and the like. The processing system 1 may require any type of data from the repair entity 23 to establish the account. Repair entity data may be input into the processing system 1 prior to activating the account. Alternatively, the repair entity 23 may be required to input certain information upon initially logging onto the processing system 1. It is noted here that historical information about the repair entity 23 may be required, including the quantity and types of repairs affected in the past, the length of time in business, as well as other types of historical data. Still, any manner of setting up a user account may be chosen as is appropriate for use with the embodiments of the subject invention. In this manner, access to information from both insuring entities 21 and the repair entities 23 may be stored in a common database system.

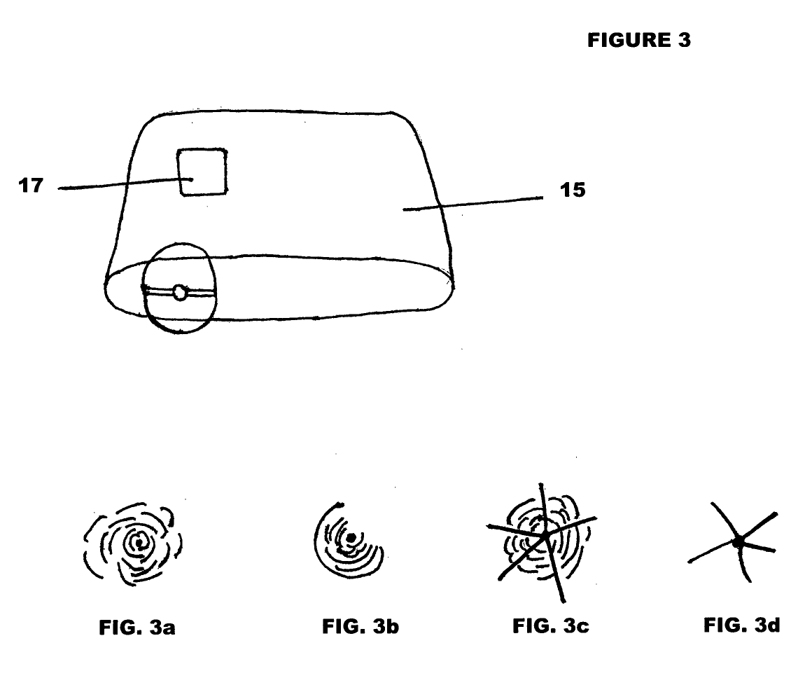

With reference again to FIG. 2 and now also to FIGS. 3 through 3d, as mentioned above, with some frequency automotive glass panels 15 may be damaged by rocks or other debris, whether the associated vehicle is in motion or sitting idle. Damage to the glass panels may occur in one or more areas, indicated in an exemplary manner at 17 as shown in FIG. 3. There are several different types of damage patterns that may be formed from impact with an object. Several patterns are shown in FIGS. 3a, 3b, 3c and 3d. When a person has realized that a glass panel has been damaged, the user 13 or operator 13 of the vehicle 12, which may be the driver or owner, may decide to file an insurance claim for the repair of the vehicle 12. Typically, the user 13 either contacts their insurance company or directly contacts an automotive glass repair center. Once the user 13 of the vehicle 15 has initiated a call to have the glass panel 15 repaired, the repair center or the insurance company may enter the insurance claim into the processing system 1.

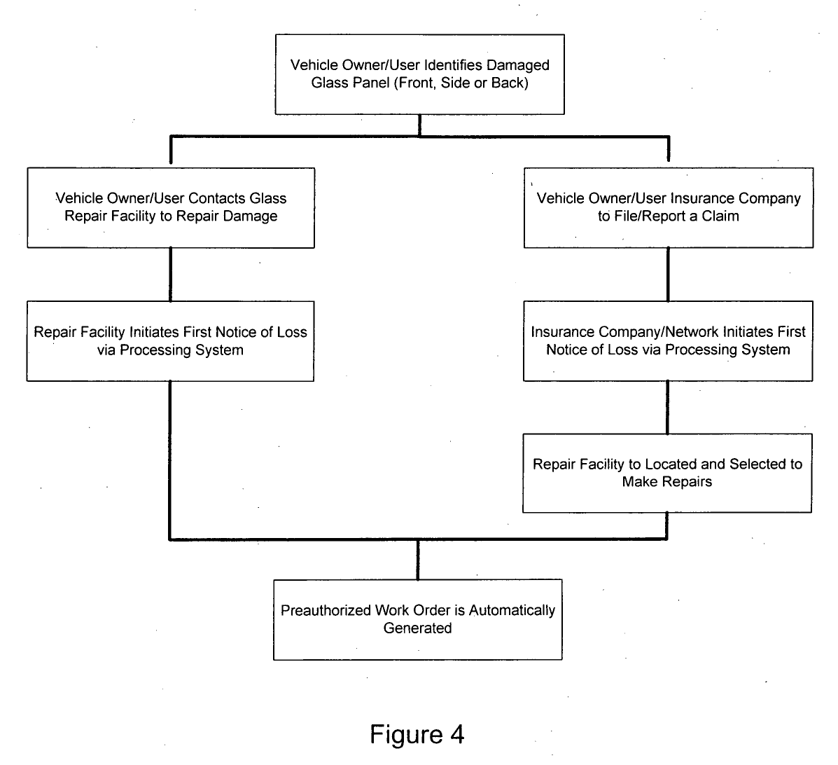

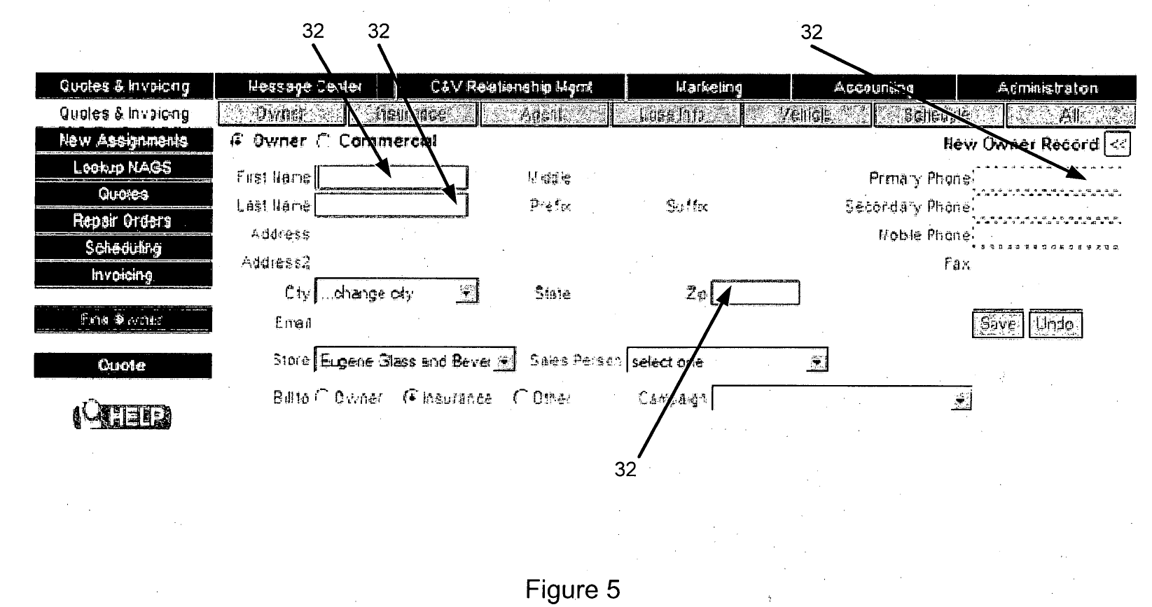

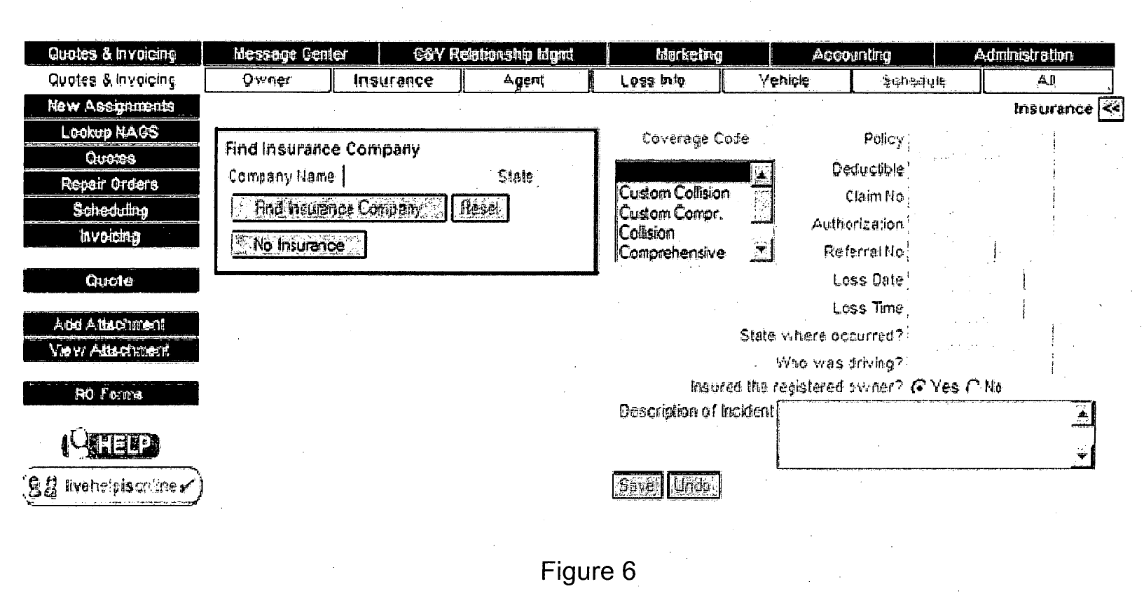

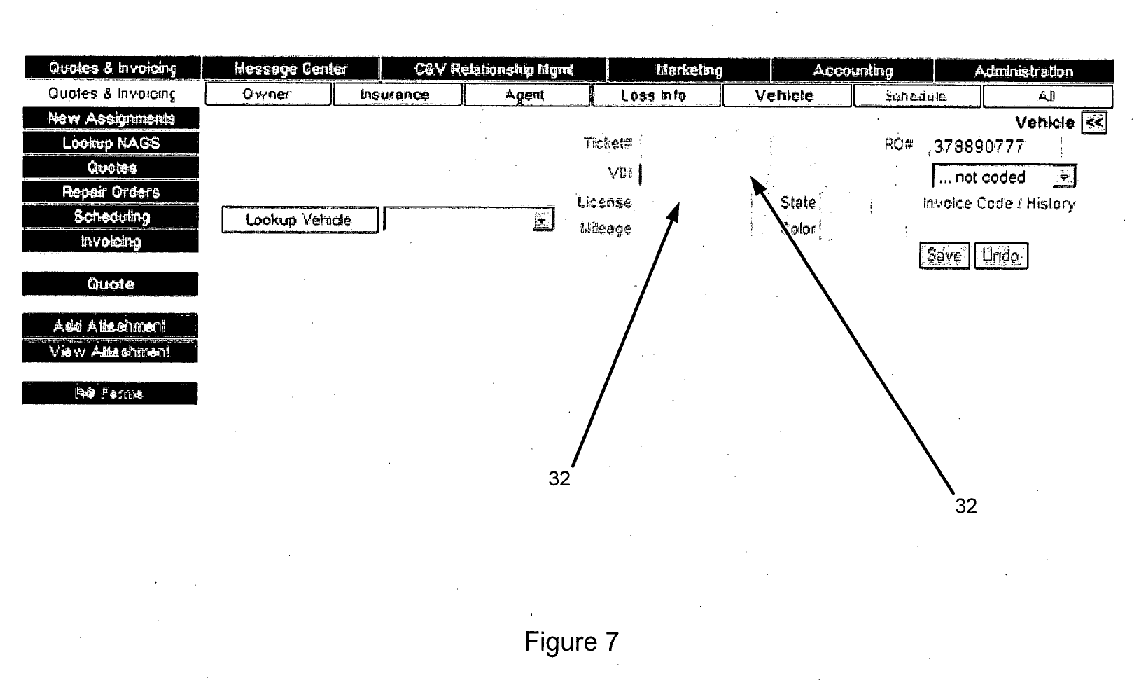

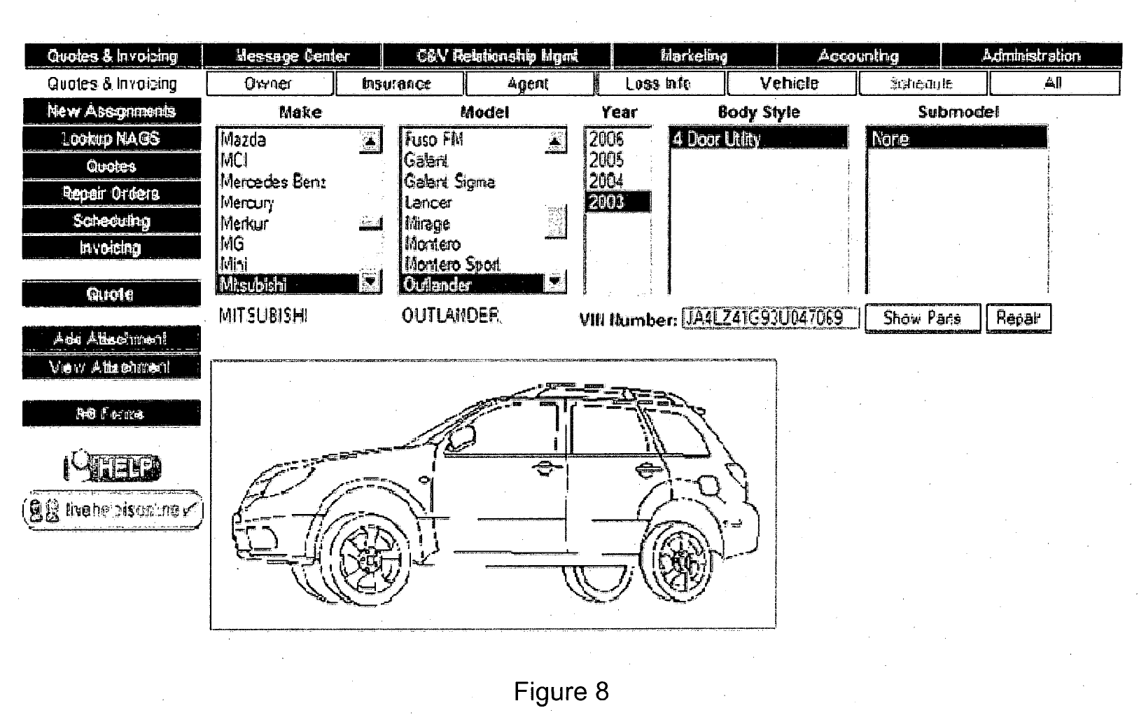

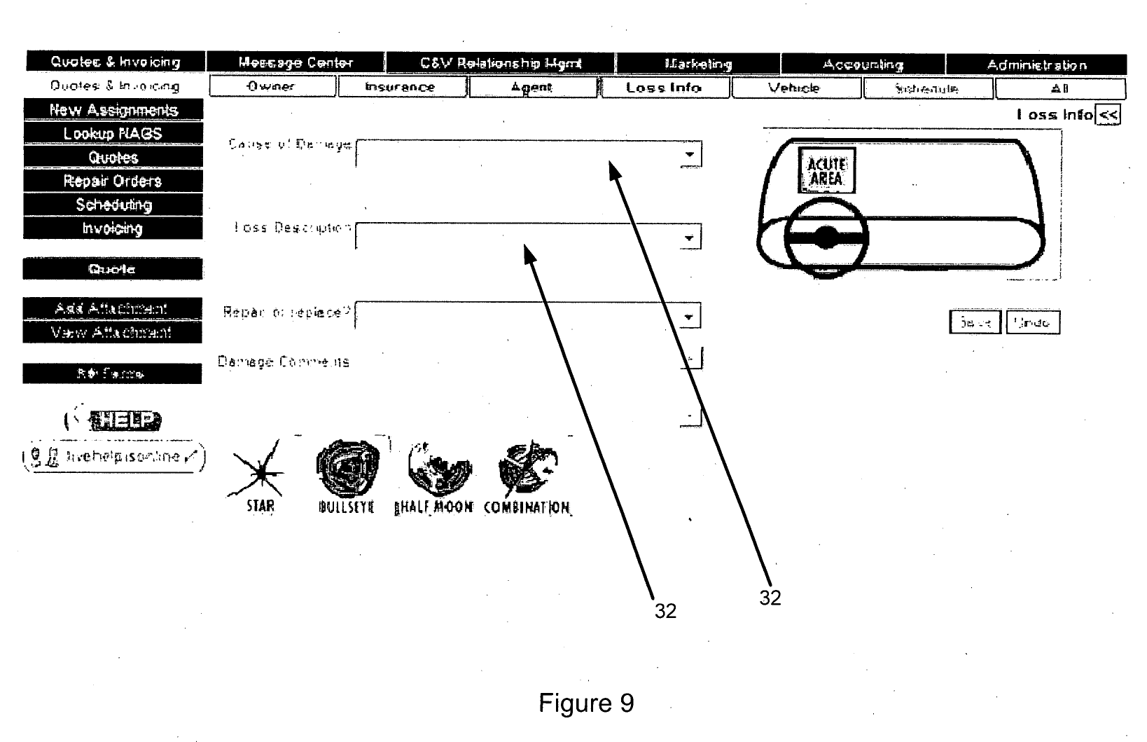

With continued reference to FIG. 2 and now to FIGS. 4 through 9, as mentioned above, the user 13 may call a glass repair center 23 directly or an insurance representative to have the glass panel 15 repaired. In the current embodiment of the subject invention, the glass repair center 23 and insurance company 21 may be subscribers 5 to the processing system 1 described herein. Either entity 21, 23 may logon to the processing system 1. Subsequently, the entity 21, 23 may navigate to the processing system 1 module for initiating first notice of loss. Data may be entered regarding the details of the damage as depicted in FIGS. 5 through 9. Certain types of data may be critical to initiating the claim, as represented by data fields 32, including for example the name of the insured party, vehicle identification number (VIN), and/or the cause and type of damage. In other words, basic information may be required to start the claim process. While additional information will be required to complete the claim, not all of the information may be necessary to begin the process. It is noted that the minimum data requirements for initiating a glass, repair claim may vary from one entity 21, 23 to the next.

With continued reference now to FIG. 4, in the embodiment where initial contact is made with the insurance company 21, a repair glass entity 23 may be selected for completing the glass repair based upon but not limited to geographical location and the type of damage to be repaired. One or more glass repair facilities may be searched from within the processing system 1, since location data as well as historical performance data are all saved within the database 14 of the processing system 1, and presented to the insured entity 13 for making the repairs. The user 13 may have the final say as to which repair facility they would prefer to have complete the repairs. However, based upon the repair capabilities, warranty history and location of a specific repair facility, the insurance company may suggest one repair facility over another. In any case, whichever glass repair facility or entity 23 is chosen, they may have access through the processing system 1 to the preauthorization and billing rules of the insurance company 21. As mentioned previously, third party administrators are currently involved in transacting business between the insurance company and the repair facility. The third party administrators may staff a call center having numerous contact representatives standing buy to interact with the parties involved. Accordingly, it is contemplated in an alternate embodiment that third party administrators may also subscribe to the processing system 1 for interaction between the insurance company and the repair glass facility. It will be appreciated that all of the benefits, associated with a standardized system of authorizing glass repairs and invoicing, will be realized by all parties utilizing the processing system 1. It is noted here that the insurance company representatives and the third party administrator representative who have access to the processing system 1 may manage the various claims, including initiating first notice of loss, through the CM module. However, it is to be construed that the insurance company representatives and the third party administrator may access and process data in the processing system 1 through any module as authorized by the processing system administrator and as is appropriate for use with the embodiments of the subject invention.

As mentioned above the insured party 13 may contact a repair facility directly to have the glass repaired. In this embodiment, the repair facility 23 may be a subscriber to the processing system 1. The repair facility 23 or repair entity 23 may receive the call from the insured party 13 and take down information needed to begin the repair process. The repair entity. 23 may logon to the processing system 1 and navigate to the module for initiating first notice of loss. In one embodiment, the repair entity 23 may navigate to the TSM module to initiate first notice of loss. Data may be entered into the processing system 1 including but not limited to the insurance company name and policy number, the insured entity contact information, and the type of damage to be repaired. In one embodiment, a search may be conducted within the processing system 1 to retrieve existing data as may have been previously entered by the insurance company 21 or other entity. The repair entity 23 may also input into the processing system 1 a proposal for repairing the damage. Once the appropriate data has been submitted, the processing system 1 may access data associated with the insurance company and the specific policy associated with the insured entity 13. The processing system 1 may verify policy coverage and then automatically apply the rules for preauthorization of the work order. In this manner, pre-approved work orders may be generated and promptly communicated back to the repair entity 23. It is noted that one of the benefits of the processing system is that the system 1 allows for preauthorization of the work orders outside of normal business hours during the week and including weekends. This streamlines the process and reduces the time to complete the repairs as may be needed. The repair entity 23 may then begin the repair process having a preauthorization from the insuring entity 21 as established by processing system 1.

The processing system 1, as discussed above, may automatically preauthorize the repair entity 23 to commence work on the subject claim. However, the type of repair to be completed may be in dispute between the insuring entity 21 and the repair entity 23. In this case, a work order may still be automatically sent to the repair entity 23. But the processing system 1 may log the discrepancy until the invoice has been submitted. The work order may also stipulate that only a certain type of repair has been preauthorized. Once the repair has been completed, the repair entity 23 may chose to submit an invoice only for the preapproved amount or may file for special consideration due to the nature of the work and the details surrounding the damage. The repair entity 23 may further submit evidence and reasons as to why the additional work was necessary. Under any circumstance, the processing system 1 provides a standardized link between the insuring entity 21 and the repair entity 23 throughout the billing procedure. It will be appreciated that the standardized link also eliminates the need to submit a separate EDI (Electronic Data Interchange) communication for submission of the invoice. This further reduces the costs associated with the repair.

Preauthorization may comprise notifying the repair entity 23 by sending an authorization number that identifies the particular claim throughout the repair process. In other words, once the repair claim data has been entered into the processing system 1, a work order and work order number may be sent to the selected repair facility 23 authorizing them to complete the repairs. It is noted here that the processing system 1 may utilize rules that access other data stored within the database 14 of the processing system 1, whereby an automatic preauthorization number and/or work order is sent to the selected repair facility 23. The rules may be generalized rules stored within the processing system 1 when the insurance company 21 initially subscribes to the system. Alternatively, the rules may be customized and entered at any time subsequent to the subscription process. In one embodiment, the rules for preauthorization may be unique to individual insurance policies. However, any type and manner of storing rules for use in preauthorizing work orders may be chosen with sound judgment as is appropriate for use with the embodiments for the subject invention. In this manner, the process of authorizing a repair is automated, streamlined and may take place on a real-time basis. The work order may also stipulate various cost and/or repair constraints. By cost constraints it is meant that the work order may limit the total invoice amount based at least in part by NAGS pricing. Other factors may also be considered when determining the cost constraints. Repair constraints may also be placed upon the repair entity 23 by the work order. That is to say that the work order may place limitations on the type of repair that is authorized. For example, a certain type of damage may only require repair of the damaged area as opposed to complete replacement of a glass panel. Accordingly, the work order may stipulate that only a repair may be completed. Again as mentioned earlier, the repair entity 23 may make additional repairs as needed and submit a request for special consideration.

In one embodiment, the repair entity 23 may take a picture of the damaged area before the work is completed. The picture may be taken by a digital camera device, as is readily available in the marketplace today. One such device may be included within a wireless telephone or other wireless mobile device. The repair technician may take one or more pictures of the damaged area and submit the pictures to the processing system 1 via an e-mail address. However, it is to be understood that any manner of transmitting digital images to the processing system 1 may be selected as is appropriate for use with the embodiments of the subject invention. The processing system 1 may require pictures to be taken before and/or after the repair has been completed. The processing system 1 may further require that the pictures be submitted prior to issuing a work order. Once the pictures have been uploaded and sent to the processing system 1, the processing system 1 may automatically retrieve the images and electronically file the images in a database with the associated claim request or work order. It is noted here that any manner of documenting and submitting the documentation to the processing system 1 may be chosen with sound engineering judgment. The documentation process may be helpful in proving what type of damaged of occurred and what type of repair was actually completed. This may be especially useful when making warranty determinations. It may be also useful to the insurance companies in helping prevent fraud.

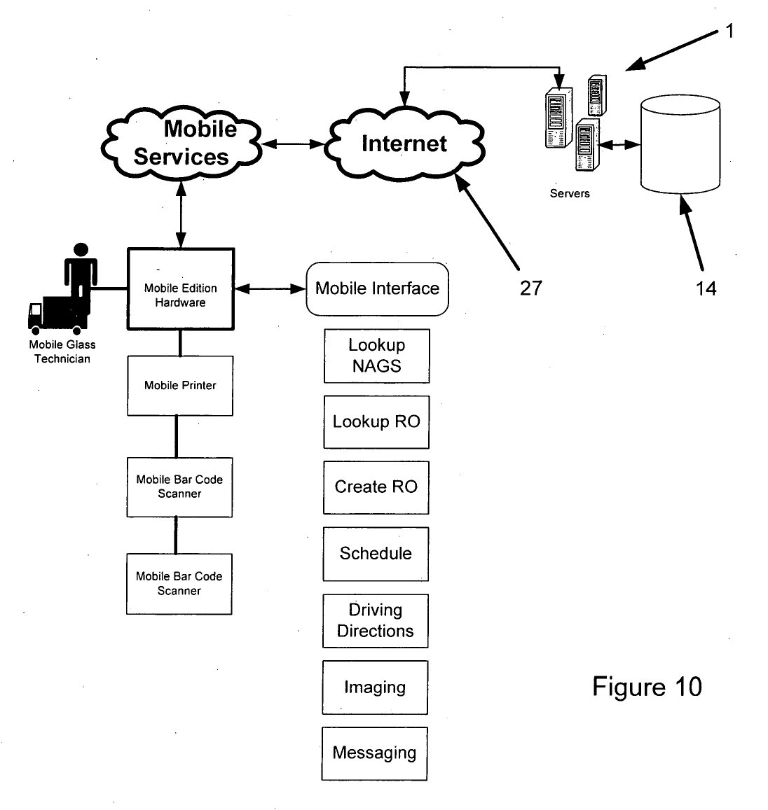

With reference to FIG. 10, the use of mobile technology may be particularly well adapted to on site repairs of glass panels 15. As mentioned earlier, a repair facility may be a mobile repair facility 23. The mobile repair facility 23 may receive a call for a glass panel repair. The mobile repair facility or entity 23 may travel to the vehicle in question. The technician may subsequently gather data while at the repair site. Using mobile computing devices and wireless communication technology, the on site repair technician may logon to the processing system 1 and submit the required data for preauthorization to complete the work. Since the processing system 1 may utilize the Internet 27 for communication, any device capable of accessing an Active Server Page, for example, may logon to the processing system 1 and gain access to the respective subscriber account. Examples of mobile devices that may be used include but are not limited to third generation wireless mobile devices. Specifically devices such as Microsoft Mobile Edition or HP iPAQ series of mobile devices may be used to access the mobile repair facility account. The versatility of communicating wirelessly through the Internet over standard wireless protocols makes the processing system 1 very powerful to the mobile repair facility by providing immediate access to preauthorization of an on-site repair. As mentioned above, the processing system 1 may require documentation of the damage. Accordingly, the mobile repair technician may take a digital picture and wirelessly communicate the picture to the processing system 1. Subsequently, the technician ray proceed with the repairs. A further point is noted here. In the situation where the repair may be completed on-site, the technician may again take a digital picture of the repaired item, complete the repair and immediately submit an invoice to the insurance company 21 via the processing system 1. This provides real time access to the billing procedures of the insurance companies saving the subscribers significant time and money as will be discussed further in the paragraphs below.

The processing system 1 may additionally include a repair order sub-module or vendor module for searching, ordering and tracking supply orders. The vendor module may be configured in any manner suitable for assisting the repair entity 23 in obtaining materials to complete the glass repair. In one embodiment, the repair entity 23 may logon to the processing system 1 and navigate to the vendor module. Similar to the other subscribers, glass material suppliers 24 may also subscribe to the processing system 1. The suppliers 24 may sell materials used by the repair entities 23. The material suppliers may update inventory, pricing, and product location, as well as other pertinent data, to the processing system 1. The information may be updated via batch process or any other means. In this way, the repair entity 23 may conveniently and quickly ascertain the availability of repair parts needed for the glass repair. In one embodiment, the vendor module may facilitate on line payment and tracking of the repair materials. However, the vendor module may be configured in any manner suitable for use with the embodiments of the subject invention.

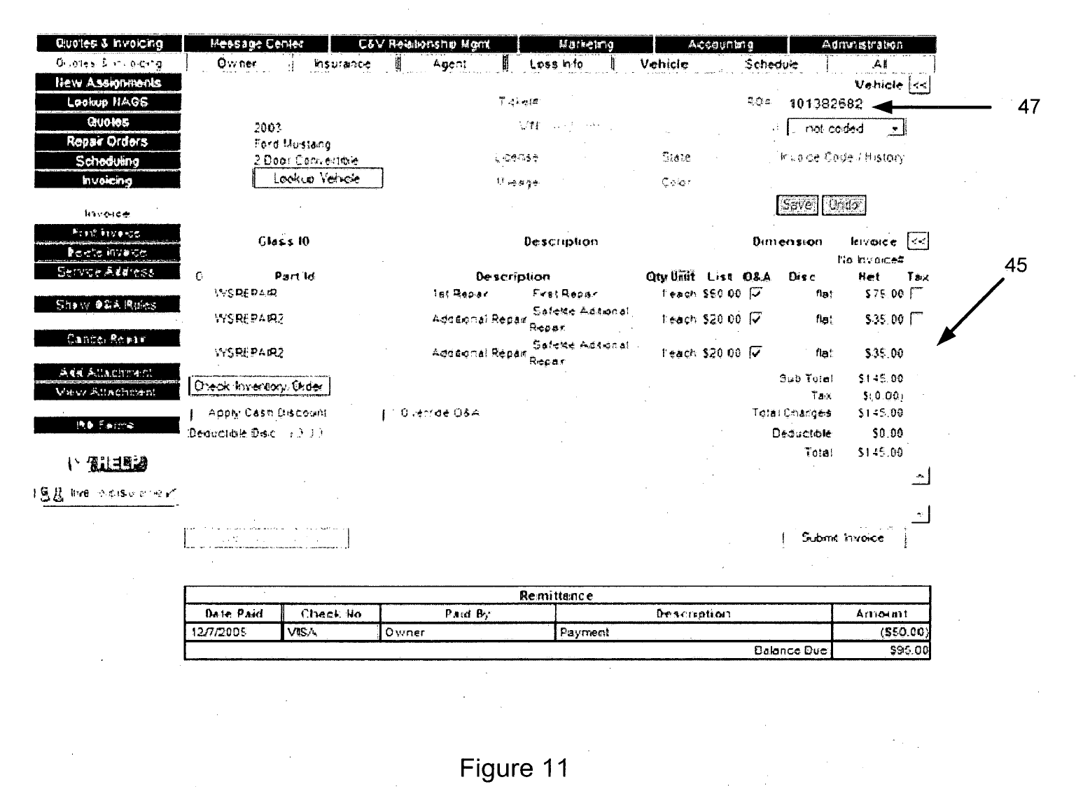

With reference now to FIG. 11, upon completion of the glass repair, the repair entity 23 may submit an invoice to the processing system 1 for payment by the insurance company 21. Much of the information associated with a specific repair may already be stored in the database 14 of the processing system 1. The repair entity 23 may search for the existing work order by entering the work order number into a search field 47. In this manner, the modules provide a query mechanism by which claim records can be retrieved. The repair entity 23 may also search for a work order by any of the fields located within the module. For example, the repair entity 23 may search for a specific work order based upon the name of the owner of the vehicle. The full name of the owner may be entered or alternatively a portion of the name may be entered along with a wild card character. The processing system 1 may then search through the database records to retrieve the desired information. A search could also be performed on the make and model or VIN number of the vehicle. However, any manner of recalling information from the database of the processing system 1 may be chosen with sound programming judgment. The repair entity 23 may subsequently select to invoice the completed work by activating a menu item associated with the invoicing process. Once the invoicing module has been activated, the repair entity 23 may complete the transaction by filling in the invoicing form 45. If the repair entity 23 performed a search for the existing repair order, portions of the invoice form 45 may already be filled in with pertinent information including for example vehicle data and contact information. The repair entity 23 may need to complete the form by entering additional information such as labor utilized to complete the repair, and parts used in the repair process, as well as other any pertinent data that may be required for submitting an invoice. Once the data has been entered, the repair entity 23 may proceed to send the invoice to the insurance company 21. In one embodiment, sending the invoice to the insurance company 21 may mean that the invoice data is simply logged and stored in the processing system 1 and a notification is sent to the insurance company indicating the invoicing process has been completed.

Current glass repair invoicing processes require the repair entity to generate an invoice and submit the invoice to the insurance company for payment. The invoices may be generated by typical word processors as are readily available in the marketplace. Invoices may also be generated by canned stand-alone software packages that provide a prearranged form into which the invoice data can be entered. Services are available that transmit the invoice and/or invoice data electronically over a communication network. Typically the electronic data transfer is transacted by another party, which may charge a per transaction fee. One aspect of submitting invoices in this way relates to the inconsistencies in billing policies that exist between different insurance companies and third party administrators. A glass repair facility may complete the work and submit an invoice only to be notified that the invoice contained some discrepancy. This greatly delays the payment process, as the repair facility has to ascertain what the discrepancy is and then resubmit the invoice. If the discrepancies are significant, the repair facility may spend a significant amount of time in phone conversation with the third party administrator and/or the insurance company. The embodiments of the subject invention describe a processing system 1 that standardizes the billing procedure rules of the insurance companies. In this way, the insurance company subscribers may enter the billing rules into the processing system database via the software interface or modules. Similar to the rules for preauthorization, the repair entity 23 may logon to the processing system 1 and navigate to the invoicing module. The invoicing module may access the policy information and the rules associated with a particular insurance company. As the repair entity 23 enters information, the processing system 1 may prompt the repair entity 23 to correct defects in the invoice as prescribed by the particular insurance company 21. This may happen in real time as the repair entity 23 representative is manually completing the form. This eliminates the discrepancies that cause delays in the billing process. In an alternate embodiment, the processing system 1 may not point out discrepancies in the invoice in real time as the repair entity is filling out the invoice but rather may automatically review the invoice as a complete document for any discrepancies. In any manner of reviewing the invoice, the processing system 1 may automatically check the invoice for defects against the rules of the particular insurance company 21. It is contemplated in an alternate embodiment, that the processing system 1 may not accept different sets of rules from different insurance companies and apply the rules on a individual policy basis. Rather the processing system 1 may require each of the subscribing insuring entities 21 to conform to a single protocol for billing procedures as defined by the processing system 1. In this manner, a standardized set of rules may be implemented for all billing procedures increasing the accuracy and effectiveness of the billing process.

Another aspect of the processing system 1 may include the capability to store and retrieve images of paper documents that are generated by the glass repair process. Invariably, the glass repair facility 23 may obtain various paper documents from any aspect of completing a glass repair. For example, the glass repair facility 23 may receive invoices from a supplier that is not a subscriber to the processing system 1. Additionally, work order releases or signed receipts from the vehicle owner may be retained as proof that a repair was completed. In fact, a myriad of paper documents may be used and/or retained by the glass repair facility or any subscriber to the system. Similarly, the insurance companies, third party administrators and even processing system administrators may also gather numerous paper documents related to the management of claim data. Accordingly, the processing system 1 may incorporate a document and image management system into one or more of the modules. The document imaging system may allow a subscriber to scan in or electronically convert the image of any paper document retained and to store the image within the processing system 1. The module display may include a prompt or activation button that allows the user to quickly and easily scan a document. The image management system may then index and store the image with no oversight by the user. It is noted that any type of scanning device may be used for this function. In one embodiment, the images are stored within the database of the processing system 1. However, any manner of storing the digitized images may be chosen with sound judgment. The digitized images may be stored with electronic tags or indexes to match the image to the appropriate claim and/or work order number. In this way, once the images are entered into the processing system 1, any subscriber, with the appropriate security profile, may access the image data at their convenience and from their remote location. The module display page may provide a link or button to access the various stored images associated with a repair claim. One important aspect of the document and image management system includes the capability to retrieve documents for a repair at any time in the past from a remote connection. As the data in the processing system 1 accumulates, the images may be archived and stored for later retrieval at the discretion of the authorized subscribers. This is important for the insurance company and/or the repair facility that may be required to retain documents for a predetermined amount of time, for example, the duration of a warranty period. The processing system 1 may store the archived data for any length of time as may be required. In this way, the subscribers may ensure compliance with various regulations for retaining documents by storing the document images on the processing system 1.

The invention has been described herein with reference to the preferred embodiment. Obviously, modifications and alterations will occur to others upon a reading and understanding of this specification. It is intended to include all such modifications and alternations in so far as they come within the scope of the appended claims or the equivalence thereof.

What is claimed is:

1. A method of processing automotive glass repair claims, the steps comprising:
providing a processing system having at least a first logic processor and memory storage, the processing system being adapted to manage a plurality of data, the processing system being adapted for selective communication to a remote device;
establishing at least a first user account with the processing system for allowing remote communication access to the plurality of data;
storing at least a first set of criteria for automatically approving the repair of automotive glass claims;
establishing a remote connection to the processing system through the at least a first user account;
receiving at least a first claim request for repairing an associated automotive glass article; and,
automatically determining an approval response to the at least a first claim based on the at least a first set of criteria.

2. The method of claim 1, wherein the step of:
providing a processing system having at least a first logic processor and memory storage, the processing system being adapted to manage a plurality of data, the processing system being adapted for selective communication to a remote device, comprises the step of:
providing a processing system having at least a first logic processor and memory storage, the processing system being adapted to manage a plurality of data, the processing system being adapted for selective communication to a remote device, the processing system having one or more modules.

3. The method of claim 2, wherein the step of:
providing a processing system having at least a first logic processor and memory storage, the processing system being adapted to manage a plurality of data, the processing system being adapted for selective communication to a remote device, the processing system having one or more modules, comprises the step of:
providing a processing system having at least a first logic processor and memory storage, the processing system being adapted to manage a plurality of data, the processing system being adapted for selective communication to a remote device, the processing system having a first software module for receiving claim requests.

4. The method of claim 1, wherein the step of:
providing a processing system having at least a first logic processor and memory storage, the processing system being adapted to manage a plurality of data, the processing system being adapted for selective communication to a remote device, comprises the step of:
providing a processing system having at least a first logic processor and memory storage, the processing system being adapted to manage a plurality of data, the processing system being adapted for selective communication to a remote device, wherein the memory storage contains at least a first portion of a database.

5. The method of claim 4, wherein the step of:
storing at least a first set of criteria for automatically approving the repair of automotive glass claims, comprises the step of:
storing at least a first set of criteria for automatically approving the repair of automotive glass claims in the at least a first portion of the database.

6. The method of claim 1, wherein the step of:
establishing at least a first user account with the processing system for allowing remote communication access to the plurality of data, comprises the step of:
establishing at least a first administrative entity account with the processing system for allowing remote communication access of at least a first administrative entity to the plurality of data.

7. The method of claim 1, wherein the step of:
establishing at least a first user account with the processing system for allowing remote communication access to the plurality of data, comprises the step of:
establishing at least a first repair entity account with the processing system for allowing remote communication access of at least a first repair entity to the plurality of data.

8. The method of claim 1, wherein the step of:
establishing at least a first user account with the processing system for allowing remote communication access to the plurality of data, comprises the step of:
establishing at least a first insuring entity account with the processing system for allowing remote communication access of at least a first insuring entity to the plurality of data.

9. The method of claim 1, wherein the step of:
establishing a remote connection to the processing system through the at least a first user account, comprises the step of:
establishing a remote connection over a wide area network to the processing system through the at least a first user account.

10. The method of claim 9, wherein the step of:
establishing a remote connection over a wide area network to the processing system through the at least a first user account, comprises the step of:
establishing a remote connection over the Internet to the processing system through the at least a first user account.

11. The method of claim 1, wherein the step of:
receiving at least a first claim request for repairing an associated automotive glass article, comprises the step of:
receiving at least a first claim request from an associated repair entity for repairing an associated automotive glass article.

12. The method of claim 1, wherein the step of:
receiving at least a first claim request for repairing an associated automotive glass article, comprises the step of:
receiving at least a first claim request from an associated insured party for repairing an associated automotive glass article; and,
further comprising the steps of:
entering claim data into the processing system; and,
dispatching a work order to an associated repair entity responsive to receiving the at least a first claim request.

13. The method of claim 12, wherein the step of:
dispatching a work order to an associated repair entity responsive to receiving the at least a first claim request, comprises the step of:
dispatching a work order to an associated repair entity responsive to receiving the at least a first claim request and responsive to data accumulated from the associated repair entity.

14. The method of claim 13, wherein the step of:
dispatching a work order to an associated repair entity responsive to receiving the at least a first claim request and responsive to data accumulated from the associated repair entity, comprises the step of:
dispatching a work order to an associated repair entity responsive to receiving the at least a first claim request and responsive to historical repair data of the associated repair entity.

15. The method of claim 12, wherein the step of:
dispatching a work order to an associated repair entity responsive to receiving the at least a first claim request, comprises the step of:
automatically generating a work order to an associated repair entity.

16. The method of claim 1, further comprising the step of:
updating NAGS pricing specification into the processing system; and,
wherein the step of:
automatically determining an approval response to the at least a first claim based on the at least a first set of criteria, comprises the step of:
automatically determining an approval response to the at least a first claim based on the at least a first set of criteria and the NAGS pricing specification.

17. A method of facilitating the repair of automotive glass, comprising the steps of:
providing a computer processing system having at least a first microprocessor and electronic memory storage, the computer processing system including one or more modules to manage the storage and retrieval of a plurality of associated data stored in a computer processing system database;
providing at least a first associated repair entity;
providing at least a first associated insurance carrier entity;
establishing a user account for the at least a first associated repair entity for authorized access the computer processing system;
establishing a user account for the at least a first associated insurance carrier entity for authorized access the computer processing system;
entering data for an insurance claim into the computer processing system from a remote location via a wide area network;
storing the data for an insurance claim in the database;
storing criteria for approving an insurance claim;
accessing the criteria for arriving at an approval decision for the insurance claim;
automatically analyzing the data for an insurance claim responsive to the criteria for insurance claim approval; and,
determining a response to the approval process of the insurance claim.

18. The method of claim 17, further comprising the step of:
notifying the at least a first associated repair entity of the response to the approval process using a computer processing system generated response.

19. The method of claim 17, wherein the step of:
accessing criteria for arriving at an approval decision for the insurance claim, comprises the step of:
retrieving criteria for arriving at an approval decision for the insurance claim from the at least a first associated insurance carrier entity.

20. The method of claim 19, further comprising the step of:
storing criteria for arriving at an approval decision for the insurance claim in the electronic memory storage; and,
wherein the step of:
retrieving criteria for arriving at an approval decision for the insurance claim from the at least a first associated insurance carrier entity, comprises the step of:
retrieving criteria for arriving at an approval decision for the insurance claim from the electronic memory storage.

21. The method of claim 19, further comprising the step of:
periodically updating the criteria for arriving at an approval decision for the insurance claim in the electronic memory storage from the at least a first associated insurance carrier entity.

22. A method of facilitating the repair of automotive glass, comprising the steps of:
providing a processing system having at least a first logic processor and memory storage, the processing system being adapted to manage a plurality of data, the processing system being adapted for selective communication to a remote device;
establishing at least a first user account with the processing system for allowing remote communication access to the plurality of data;
storing at least a first set of criteria for automatically approving the repair of automotive glass claims;
establishing a remote connection to the processing system through the at least a first user account;
receiving at least a first claim request for repairing an associated automotive glass article;
accessing data for automatically verifying insurance policy coverage;
automatically determining an approval response to the at least a first claim based on the at least a first set of criteria; and,
receiving at least a first invoice request for repairing the associated glass article; and,
automatically approving the at least a first invoice request based upon the determined approval response.

23. The method of claim 22, wherein the step of:
establishing at least a first user account with the processing system for allowing remote communication access to the plurality of data;
comprises the step of:
establishing a first user account with the processing system for allowing an associated repair entity remote communication access to the plurality of data and at least a second user account with the processing system for allowing an associated insurance carrier entity remote communication access to the plurality of data.

24. The method of claim 23, further comprising the steps of:
automatically generating a disbursement request for payment of the at least a first invoice; and,
sending the disbursement request to the associated insurance carrier entity.
